(19) United States
(12) Patent Application Publication
(10) Pub. No.: US 2006/0110670 A1
(43) Pub. Date: May 25, 2006

(54) In situ method for passivating the surface of a photoreceptor substrate

(76) Inventors: Jin Wu, Webster, NY (US); Yuhua Tong, Webster, NY (US); Geoffrey M. T. Foley, Fairport, NY (US); Liang-Bih Lin, Rochester, NY (US); Andronique Ioannidis, Webster, NY (US); Nancy L. Belknap, Rochester, NY (US)

Correspondence Address: PILLSBURY WINTHROP SHAW PITTMAN, LLP, P.O. BOX 10500, MCLEAN, VA, 22102, US

(21) Appl. No.: 10/996,090

(22) Filed: Nov. 23, 2004

(51) Int. Cl. G03G 5/147; B05D 3/02

(52) U.S. Cl. 430/60; 430/131; 427/372.2

(57) ABSTRACT

An electrophotographic photoreceptor is disclosed which is provided with a substrate with a coating with a metal oxide as an interface between the substrate and photoconductive layers. A process for applying the metal oxide layer to the substrate is also disclosed.

### BACKGROUND

Disclosed is a process for passivating the surface of a substrate in the manufacture of products such as electrophotographic photoreceptors. More specifically, illustrated herein is a process for preventing degradation or loss of integrity of the photoconductive layer interface with the metal substrate in improving the lifespan of photoreceptors.

An electrophotographic photoreceptor is a device used inside of a xerographic marking system on which a latent image is written by a laser or light emitting diode (LED) bar and then developed with a toner. An electrophotographic photoreceptor comprises, for example, a photosensitive layer that may consist of multiple layers including, a charge transport layer (CTL), a charge-generating layer (CGL), an undercoat (UCL) or “blocking” layer, and a supporting substrate layer or base. An overcoat layer (OCL) may also be employed to coat the charge transport layer and protect the charge transport layer, extending the mechanical life of the photoreceptor, in some instances, as much as 10-fold over uncoated photoreceptors of the same make.

Photoreceptors under long, repeated use and high stress conditions, such as, high temperature, high relative humidity, and rapid cycling, degrade or lose integrity of the layers making up the photoreceptor. Degradation of the layers of the photoreceptor may be observed as black spots in prints. Such black spots may develop as a result of charge deficient spots and cyclic instability of the photoreceptor. Print defects associated with charge deficient spots, or black spots, are therefore, a major shortcoming in xerographic systems and usually attributed to electrical leakage across the photoreceptor layers at those spots.

Although sources of electrical leakage are multifold, electrical leakage frequently involves degradation of interfaces among the three active layers of the photoreceptor, i.e., undercoat layer, charge generating layer, and charge transporting layer, and in particular, between the undercoat layer and substrate. The intrinsic life of a photoreceptor is significantly affected by the electrochemical reactions at the metal substrate/photoconductive layer interface. Degradation of the interface induces a conductive path transversal of the photoreceptor and causes electrical leakage. To minimize degradation, most available methods are directed at improving the composition of the three active layers, individually. The interfaces between the component layers of the photoreceptors often have been ignored because they are inherently difficult to investigate.

Undercoat layers are required to provide an effective barrier against hole injection from the substrate. Undercoat layers need to permit efficient electron transport at interfaces with the substrate, and in the bulk of the layer, provide plywood suppression, and provide a barrier against foreign material impaction, as well as have good adhesion properties.

Thus, there is a need to produce photoreceptors that resist degradation of the photoconductive layers, in particular photoreceptors that maintain the integrity of the interface between the substrate and photoconductive layers for a prolonged period of time so that the life of photoreceptor can be extended.

To extend the functional life of a photoreceptor, comprising for example, an aluminum substrate, the surface of the substrate can be passivated to form, for example, an aluminum oxide layer. A process available for forming an aluminum oxide layer on the surface of a photoreceptor is anodization. Anodizing can be viewed as the deliberately controlled corrosion of the aluminum surface in acid to yield a uniform, continuous protective oxide film. Although anodization of aluminum substrates extends the life of the photoreceptor, relatively higher residual potential caused by the anodized layer can be problematic to the proper function of the photoreceptor. Also, the anodization process may require the use of strong acids, large amounts of water and electrical power, making the process difficult and dangerous to operate. Therefore, there is a need to find alternative, less complicated and safer processes to form a metal oxide layer on the surface of a photoreceptor substrate.

### SUMMARY

Aspects disclosed herein include

an electrophotographic photoreceptor comprising a substrate having an outer surface with a coating layer attached thereon, the coating layer comprising a metal oxide; wherein the coating layer is formed in situ by applying a solution to the substrate, said solution comprising an organometallic compound and a polar organic solvent and/or water; and curing the solution at a temperature of from about 300° C. to about 600° C.; and

a process comprising forming a coating in situ on a substrate, the coating comprising a metal oxide, wherein the coating is formed by applying a solution comprising an organometallic compound and a polar organic solvent and/or water to said substrate and curing the solution on the substrate in an oven at a temperature of from about 300° C. to about 600° C.

### DETAILED DESCRIPTION

In embodiments there is illustrated:

an electrophotographic photoreceptor for use with a xerographic system comprising a charge transport layer, a charge generating layer; optionally an undercoat layer, and a substrate, wherein said substrate has an outer surface comprising a coating comprising a metal oxide.

The photoreceptor substrate may be comprised of a rigid or a flexible material and may have any number of different configurations such as a plate, a cylinder or drum, a sheet, a scroll, a flexible web, an endless flexible belt, and the like, and can be selected from various materials, including an electrically insulating or non-conductive material, or a conductive material such as aluminum, aluminum alloys, titanium, titanium alloys, copper, copper iodide, brass, gold, zirconium, nickel, stainless steel, tungsten, chromium, or any other electrically conductive or insulating substance.

The coating on the substrate comprises a metal oxide layer such as, zirconium oxide, or titanium oxide, and is applied in situ using a solution comprising an organometallic compound and a polar organic solvent and/or water.

The organometallic compound can be, for example, a hydrolytically stable organic compound, for example, an organic titanate or an organic zirconate for a metal substrate such as in aluminum substrate passivation. The hydrolytically stable organic titanate/zirconate may include, for example: TYZOR 131 (an aqueous titanate chelate by Dupont); TYZOR JT-1 (an aqueous titanium acetylacetone chelate by Dupont); TYZOR 217 (an aqueous zirconium lactate by Dupont); TYZOR 218 (an aqueous zirconium glycolate by Dupont); TYZOR PEL-F; TYZOR PEL-G and the like. The organometallic compound can also be, for example, an alcoholytically stable organic compound, for example, an organic titanate or an organic zirconate for use in an aluminum substrate passivation. The alcoholytically stable organic titanate/zirconate may include, for example: titanium acetylacetone chelates such as TYZOR AA, GBA, GBO, AA-75, AA-65, AA-105 by Dupont; titanium ethylacetoacetate chelates such as TYZOR DC, IBAY by Dupont; titanium ethylacetoacetate/silane chelates such as TYZOR PITA SM by Dupont; titanium triethanolamine chelates such as TYZOR TE, TEP by Dupont; TYZOR TEAZ (a chelate of triethanolamine zirconate by Dupont); TYZOR ZEC (a diethylcitrate chelated zirconate by Dupont); TYZOR 212 (alkanolamine zirconate); and the like.

Organometallic titanates may be used in making the coating, including compounds such as a lactic acid titanium chelate having the formula: 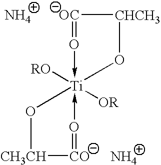
Such as TYZOR LA; or a titanium acetylacetone chelate having the formula: 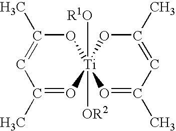
such as TYZOR AA, wherein R¹ and R² are i-C₃H₇, in isopropanol; TYZOR GBA, wherein R¹ and R² are i-C₃H₇, in isopropanol/butanol/methanol; TYZOR GBO wherein R¹ and R² are i-C₃H₇, in isopropanol/butanol/methanol; TYZOR AA-75, wherein R¹ and R² are i-C₃H₇, in isopropanol; TYZOR AA-65, wherein R¹ is C₂H₅ and R² is i-C₃H₇, in isopropanol/ethanol; TYZOR AA-105, wherein R¹ is C₂H₅ and R²=i-C₃H₇);
or titanium ethylacetate chelates having the formula: 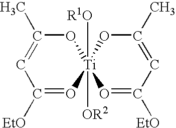
such as TYZOR DC, wherein R¹ and R² are i-C₃H₇; TYZOR IBAY, wherein R¹ and R² are i-C₄H₉;
or titanium triethanolamine chelates of the formula: 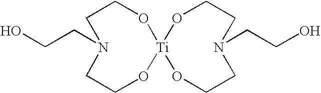
such as TYZOR TE.

The organometallic compound may be used at low concentrations of from about 0.05% to about 50%, or from about 0.1% to about 20% in water with a polar organic solvent, such as methanol, ethanol, isopropanol, propanol, butanol, isobutanol and the like in a concentration such as from 0 parts to about 90 parts of water depending on the organic solvent used.

In another embodiment, a process is provided which comprises forming a metal oxide coating onto a substrate of an electrophotographic photoreceptor, the metal oxide coating being formed in situ by applying a solution comprising an organometallic compound and a polar organic solvent, and/or water, as defined above, and curing the solution at a temperature of from about 300° C. to about 600° C. The high temperatures lead to the decomposition of the organometallic compound to form its metallic oxide form. The curing can be performed, for example, for from about 30 minutes to about 1.5 hours, or from about 45 minutes to about 1 hour at the required temperature to decompose the organometallic compound.

The coating solution can be applied by processes such as dipping, spinning, spraying, roller coatings and plasma enhanced chemical vapor deposition. After coating, the coated substrate is subject to thermal cure at high temperatures in an oven set at, for example, from about 300° C. to about 600° C., or from about 350° C. to about 500° C. The metal oxide layer such as a titanium oxide or zirconium oxide layer may be formed in situ by thermal decomposition of the organometallic compound, respectively, for example, organic titanate or organic zirconate. Following the curing step, the coated substrate may be cooled at room temperature prior to applying other layers of the photoreceptor.

The thickness of the metal oxide layer applied to the photoreceptor may vary depending on the organometallic compound used, and can be adjusted with the concentration of the organometallic compound used.

The charge generating layer can be made of various materials, including layers of a binder polymeric resin material or a film including particles, or resin layers including a photoconductive material such as vanadyl phthalocyanine, metal free phthalocyanine, hydroxygallium phthalocyanine, titanyl phthalocyanine, chlorogallium phthalocyanine, alkoxygallium phthalocyanine, benzimidazole perylene, amorphous selenium, trigonal selenium, selenium alloys such as selenium-tellurium, selenium-telluriumarsenic, selenium arsenide, and the like, and mixtures thereof. Suitable polymeric films forming binder materials include, but are not limited to thermoplastic and thermosetting resins such as polycarbonates, polyesters, polyamides, polyurethanes, polystyrenes, polyarylethers, polyarylsulfones, polybutadienes, polysulfones, polyethersulfones, polyethylenes, polypropylenes, polyimides, polymethylpentenes, polyphenylene sulfides, polyvinyl acetate, polysiloxanes, polyacrylates, polyvinyl acetals, amino resins phenylene oxide resins, terephthalic acid resins, phenoxy resins, epoxy resins, phenolic resins, polystyrene and acrylonitrile copolymers, polyvinyl chloride, vinylchloride and vinyl acetate copolymers, acrylate copolymers, alkyd resins, cellulosic film formers, poly(amideimide), styrene-butadiene copolymers, vinylidinechloride-vinylchloride copolymers, vinylacetate-vinylidenechloride copolymers, vinylacetate-vinylidenechloride copolymers, styrene-alkyd resins, polyvinylcarbazole, and the like, and mixtures thereof. The charge generating layer may comprise a photogenerating composition or pigments and can be applied by various techniques including, chemical vaporization, sputtering, spraying and dipping.

The photogenerating composition or pigment is present in the resinous binder composition in various amounts, ranging from about 5% by volume to about 90% by volume of the photogenerating pigment is dispersed in about 10% by volume to about 95% by volume of the resinous binder; or from about 20% by volume to about 30% by volume of the photogenerating pigment is dispersed in about 70% by volume to about 80% by volume of the resinous binder composition. In one embodiment, about 8 percent by volume of the photogenerating pigment is dispersed in about 92 percent by volume of the resinous binder composition. The photogenerating layer containing photoconductive compositions and/or pigments and the resinous binder material ranges in thickness of from about 0.1 μm to about 5.0 μm, or from about 0.3 μm to about 3 μm. The photogenerating layer thickness is related to binder content, for example, higher binder content compositions require thicker layers for photogeneration. Thicknesses outside these ranges can also be selected.

The charge transport layer can be made of several materials, including, electrically active organic resin materials such as polymeric arylamine compounds and related polymers, including polysilylenes such as poly(methylphenyl silylene), poly(methylphenyl silylene-co-dimethyl silylene), poly(cyclohexylmethyl silylene), polyvinyl pyrenes and poly(cyanoethylmethyl silylene). In an embodiment, a photoconductive imaging member comprises a charge transport layer comprising an aryl amine of the formula:

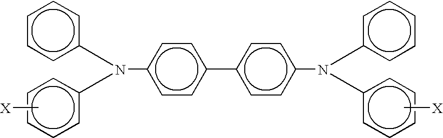

wherein X can be an alkyl and/or a halogen, and wherein the aryl amine is dispersed in a resinous binder, and alkyl may comprise one or more carbons such as methyl, ethyl, and propyl; halogen can be chlorine, or fluorine, and the resinous binder can be a polycarbonate or a polystyrene. An exemplar aryl amine for a photoconductive imaging member can be N,N′-diphenyl-N,N-bis(3-methyl phenyl)-1,1′-biphenyl-4,4′-diamine. The thickness of the charge transport layer may range from about 2 μm to about 100 μm; or from about 5 μm to about 50 μm, or from about 10 μm to about 30 μm, and can be applied by similar techniques as those used for applying the charge generating layer, such as chemical vaporization, spraying, dipping, spin and roller coating. The transport layer should be an insulator to the extent that the electrostatic charge placed on the transport layer is not conducted in the absence of illumination at a rate sufficient to prevent formation and retention of an electrostatic latent image thereon. In an embodiment, the ratio of the thickness of the transport layer to the charge generator layer is from about 2:1 to 200:1 and in some instances as great as about 400:1.

The photoreceptor may also comprise an overcoat layer to protect the charge transport layer and increase resistance to abrasion. The overcoat layer may range in thickness of from about 2 μm to about 10 μm, or from about 3 μm to about 7 μm. In an embodiment, an overcoat layer comprising a film forming polymer binder can also be employed. In this embodiment, the overcoat layer may comprise an outer layer in which a surface energy reducing, hole transporting polymer may be added. Overcoatings without a surface energy reducing, hole transporting polymer additive are either electrically insulating or slightly hole transporting. Any suitable and conventional technique which include spraying, extrusion coating, dip coating, roll coating, wire wound rod coating, and the like may be utilized to mix and thereafter apply the overcoat coating mixture to the underlying layer of the photoreceptor, such as over the charge transport layer. After the overcoat layer is applied, the overcoat composition is dried by several methods, for example, oven drying, infrared radiation drying, and air impingement drying.

An undercoat having a hole-blocking layer may be optionally applied to the conductive surface of the substrate. Electron-blocking layers for positively charged photoreceptors allow holes from the imaging surface of the photoreceptor to migrate toward the conductive layer. Some materials can form a layer that functions as both an adhesive layer and charge blocking layer. Typical blocking layers include polyvinylbutyral, organosilanes, epoxy resins, polyesters, polyamides, polyurethanes, silicones and the like. The polyvinylbutyral, epoxy resins, polyesters, polyamides, and polyurethanes can also serve as an adhesive layer. Adhesive and charge blocking layers preferably have a dry thickness between about 0.002 μm (20 Angstroms) and about 0.2 μm (2,000 Angstroms). Silanes and silane reaction products such as those described in U.S. Pat. No. 4,464,450, which entire disclosure is incorporated herein by reference, can be used as effective hole blocking layer material, because its cyclic stability is extended. Silanes that can be used for making the hole blocking layer of the photoreceptor include, hydrolyzable silanes, such as 3-aminopropyltriethoxysilane, N-aminoethyl-3-aminopropyltrimethoxy-silane, N-2-aminoethyl-3-aminopropyltrimethoxy silane, N-2-aminoethyl-3-aminopropyltris(ethylethoxy) silane, p-aminophenyl trimethoxysilane, 3-aminopropyldiethylmethylsilane, (N,N′-dimethyl 3-amino)-propyltriethoxy-silane, 3-aminopropylmethyldiethoxysilane, 3-aminopropyl trimethoxy-silane, N-methylaminopropyltriethoxysilane, methyl[2-(3-trimethoxysilylpropylamino)-ethylamino]-3-proprionate, (N,N′-dimethyl 3-amino)propyl triethoxysilane, N,N-dimethylaminophenyltriethoxysilane, trimethoxysilylpropyl diethylenetriamine and mixtures thereof. Good hole blocking properties may be achieved when the reaction product of a hydrolyzed silane and metal oxide layer forms a blocking layer having a thickness of from about 0.002 μm to about 0.2 μm.

In one embodiment, the hole blocking layer comprises a reaction product between a hydrolyzed silane and an oxidized surface of a metal ground plane layer. In this embodiment, the oxidized surface inherently forms on the outer surface of most metal ground plane layers when exposed to air after vacuum deposition of the hole blocking layer. The hole blocking layer may be applied by any suitable technique such as spraying, dip coating, draw bar coating, gravure coating, reverse roll coating, vacuum deposition, chemical treatment and the like. In an embodiment, thin hole blocking layers may be obtained when the hole blocking layer is applied in the form of a dilute solution, with the solvent being removed after deposition of the coating, for example, by vacuum, heating and the like. The hole-blocking layer may be continuous and can have a thickness of less than about 0.2 μm to about 0.5 μm after drying because greater thicknesses may lead to undesirably high residual voltage; or form about 0.05 μm to about 0.3 μm; or from about 0.005 μm to about 0.03 μm. The hole-blocking layer can also be particulate, in which pigment particles are dispersed in a polymeric binder. The pigments include, but are not limited to, titanium dioxide, zinc oxide, tin oxide and other metal oxides. The polymeric binder can include but is not limited to, for example, phenolic resin, poly(vinyl butyral), polyamide and other polymers. The pigment/binder (weight/weight) ratio varies from about 30/70 to about 80/20. The thickness of the undercoat layer may vary from about 1 μm to about 30 μm.

An optional adhesive layer may be applied to the hole blocking layer blocking layer. Any suitable adhesive layer may be utilized, for example, polyesters, DuPont 49,000 (available from E. I. DuPont de Nemours and Company), Vitel PE100 (available from Goodyear Tire & Rubber), polyurethanes, and the like. Good adhesive properties may be achieved with an adhesive layer ranging in thickness of from about 0.05 μm (500 angstroms) and about 0.3 μm (3,000 angstroms). The adhesive layer coating mixture can be applied over the hole blocking layer by methods such as spraying, dip coating, extrusion coating, roll coating, wire wound rod coating, gravure coating, and Bird applicator coating. After the adhesive is applied, the adhesive is dried to form a coating by a method such as oven drying, infra-red radiation drying, air impingement drying, and vacuum drying.

Specific embodiments of the disclosure will now be described in detail. These Examples are intended to be illustrative, and the invention is not limited to the materials, conditions, or process parameters set forth in these embodiments. All parts and percentages are by weight unless otherwise indicated.

### EXAMPLE 1

Aluminum photoreceptor substrates were prepared by coating the substrates with an aqueous solution consisting of 2 parts of lactic acid titanium chelate, TYZOR LA by Dupont; 68 parts of methanol and 30 parts of water using the method of ring coating. After coating, the substrates were subjected to thermal cure in an oven at a temperature of 500° C. for 1 hour to form a light blackish layer on the aluminum surface.

### EXAMPLE 2

Aluminum photoreceptor substrates were prepared by coating the substrates with an aqueous solution consisting of 20 parts of lactic acid titanium chelate, TYZOR LA by Dupont; 80 parts of methanol using the method of ring coating. After coating, the substrates were subjected to thermal cure in an oven at a temperature of 350° C. for 1 hour to form a light blackish layer on the aluminum surface.

### EXAMPLE 3

Aluminum photoreceptor substrates were prepared by coating the substrates with an aqueous solution consisting of 20 parts of aqueous zirconium glycolate, TYZOR 218 by Dupont; 80 parts of methanol using the method of ring coating. After coating, the substrates were subjected to thermal cure in an oven at a temperature of 450° C. for 1 hour to form a light blackish layer on the aluminum surface.

### EXAMPLE 4

Aluminum photoreceptor substrates were prepared by coating the substrates with an aqueous solution consisting of 20 parts of titanium acetylacetone chelate, TYZOR AA-75 by Dupont; 80 parts of isopropanol using the method of ring coating. After coating, the substrates were subjected to thermal cure in an oven at a temperature of 450° C. for 1 hour to form a light blackish layer on the aluminum surface.

### EXAMPLE 5

Full photoreceptor devices were prepared using treated aluminum substrates prepared as described in Examples 1-4 above as well as untreated aluminum substrates as controls. Devices included an optional undercoat layer, a charge generating layer and a charge transport layer. The undercoat layer was prepared as follows. A titanium oxide/phenolic resin dispersion was prepared by ball milling for 5 days 15 grams of titanium dioxide (STR60N™, Sakai Company), 20 grams of the phenolic resin (VARCUM™ 29159, OxyChem Company, M_{w} of about 3,600, viscosity of about 200 cps) in 7.5 grams of 1-butanol, and 7.5 grams of xylene with 120 grams of 1 millimeter diameter sized ZrO₂ beads. Separately, a slurry of SiO₂ and a phenolic resin was prepared by adding 10 grams of SiO₂ (P100, Esprit) and 3 grams of the above phenolic resin into 19.5 grams of 1-butanol and 19.5 grams of xylene. The resulting titanium dioxide dispersion was filtered with a 20 micrometer pore size nylon cloth, and then the filtrate was measured with Horiba Capa 700 Particle Size Analyzer, and a median TiO₂ particle size of 50 nanometers in diameter was obtained which had a surface area of 30 m²/gram with reference to the above TiO₂/VARCUM™ dispersion. Additional solvents of 5 grams of 1-butanol, and 5 grams of xylene; 2.6 grams of bisphenol S (4,4′-sulfonyldiphenol), and 5.4 grams of the above prepared SiO₂/VARCUM™ slurry were added to 50 grams of the above resulting titanium dioxide/VARCUM™ dispersion, referred to as the coating dispersion. A 30 millimeters in diameter and 340 millimeters in length aluminum pipe cleaned with detergent and rinsed with deionized water was dip coated with the coating dispersion at a pull rate of 160 millimeters/minute, and subsequently, dried at 160° C. for 15 minutes, which resulted in an undercoat layer (UCL) comprised of TiO₂/SiO₂/VARCUM™/bisphenol S with a weight ratio of about 52.7/3.6/34.5/9.2 and a thickness of 3.5 microns. A 0.5 micron thick charge generating layer (CGL) was subsequently coated on top of the above generated undercoat layer from a dispersion of either chlorogallium phthalocyanine (CIGaPc) Type B (3 parts) or hydroxygallium phthalocyanine (HOGaPc) Type V (3 parts), and a vinyl chloride/vinyl acetate copolymer, VMCH™ (Mₙ equal to 27,000, about 86 weight percent of vinyl chloride, about 13 weight percent of vinyl acetate and about 1 weight percent of maleic acid) available from Dow Chemical (2 parts), in 95 grams of toluene/n-butylacetate with a weight ratio of 2 to 1. A 25 μm thick charge transport layer (CTL) was coated on top of the photogenerating layer from a solution containing 8.8 parts of N,N′-diphenyl-N,N-bis(3-methyl phenyl)-1,1′-biphenyl-4,4′-diamine and 13.2 parts of polycarbonate, PCZ-400 [poly(4,4′-dihydroxy-diphenyl-1-1-cyclohexane, M_{w} equal to 40,000)], Mitsubishi Gas Chemical Company, Ltd. in a mixture of 55 grams of tetrahydrofuran (THF) and 23.5 grams of toluene. The CTL was dried at 120° C. for 45 minutes.

The above devices were electrically tested with an electrical scanner set to obtain photoinduced discharge cycles (PIDC), sequenced at one charge-erase cycle followed by one charge-expose-erase cycle, wherein the light intensity was incrementally increased with cycling to produce a series of photoinduced discharge characteristic curves from which the photosensitivity and surface potentials at various exposure intensities were measured. Additional electrical characteristics were obtained by a series of charge-erase cycles with incrementing surface potential to generate several voltage versus charge density curves. The scanner was equipped with a scorotron set to a constant voltage charging at various surface potentials. The devices were tested at surface potentials of 700 volts with the exposure light intensity incrementally increased by means of regulating a series of neutral density filters; the exposure light source was a 780 nanometer light emitting diode. The xerographic simulation was completed in an environmentally controlled light tight chamber at ambient conditions (40 percent relative humidity and 22° C.). Table 1 below summarizes the results obtained in these experiments.

TABLE 1

| | V_{low} of 10 erg/cm² | | |
|---|---|---|---|
| | Exposure Energy and | | |
| | 83 ms Charge to | dV/dX | |
| Device | Exposure Delay (V) | (Vcm²/erg) | V_{depletion} (V) |
| Example 1 with | 90 | 366 | 50 |
| HOGaPc CGL | | | |
| Untreated Al | 89 | 365 | 52 |
| substrate with | | | |
| HOGaPc CGL | | | |
| Example 2 with | 91 | 205 | 40 |
| ClGaPc CGL | | | |
| Untreated Al | 90 | 200 | 45 |
| substrate with | | | |
| HOGaPc CGL | | | |

As illustrated in Table 1, V_{low} is the surface potential of the device subsequent to a certain light exposure at a certain time delay after exposure; dV/dx is the initial slope of the PIDC curve and is a measurement of sensitivity; and V_{depletion} is linearly extrapolated from the surface potential versus charge density relation of the devices, and is a measurement of voltage leak during charging. The data indicate that the photo-induced discharge curves do not change with addition of an extra metal oxide layer on aluminum substrates. However, long cycle stress tests of the metal oxide-passivated devices have demonstrated that the cyclic life of photoreceptor can be measured up to an average of about 850 kilocycles without any black spots appearing in printouts, which is an improvement over untreated devices. Untreated devices average approximately 510 kilocycles before black spots begin appearing in print.

It will be appreciated that various of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims.

What is claimed is:

1. An electrophotographic photoreceptor comprising a substrate having an outer surface with a coating layer attached thereon, said coating layer comprising a metal oxide, wherein said coating layer is formed in situ by applying a solution to said substrate, said solution comprising an organometallic compound and a polar organic solvent and/or water; and curing said solution at a temperature of from about 300° C. to about 600° C.

2. The electrophotographic photoreceptor in accordance with claim 1, wherein said metal oxide is titanium oxide or zirconium oxide.

3. The electrophotographic photoreceptor in accordance with claim 1, wherein the organometallic compound is a hydrolytically stable organic titanate, a hydrolytically stable zirconate, an alcoholytically stable titanate, or an alcoholytically stable zirconate.

4. The electrophotographic photoreceptor in accordance with claim 3, wherein said hydrolytically stable organic titanate is titanium lactate, titanium acetylacetone chelate or combinations thereof.

5. The electrophotographic photoreceptor in accordance with claim 3, wherein said hydrolytically stable zirconate is zirconium lactate, zirconium glycoate or combinations thereof.

6. The electrophotographic photoreceptor in accordance with claim 3, wherein said alcoholytically stable organic titanate is titanium acetylacetone chelate, titanium acetylacetone/silane chelate, titanium ethylacetoacetate chelate, titanium triethanolamine chelate or combinations thereof.

7. The electrophotographic photoreceptor in accordance with claim 3, wherein said alcoholytically stable organic zirconate is diethylcitrate chelated zirconate, triethanolamine zirconate or combinations thereof.

8. The electrophotographic photoreceptor in accordance with claim 1, wherein said outer surface of said substrate comprises aluminum, aluminum alloy, titanium, titanium alloys, copper, copper iodide, brass, gold, zirconium, nickel, stainless steel, tungsten, chromium, or combinations thereof.

9. The electrophotographic photoreceptor in accordance with claim 1, wherein said organometallic compound is in a concentration in said solution of from about 0.05% to about 50%, or from about 0.1% to about 20%.

10. The electrophotographic photoreceptor in accordance with claim 1, wherein said polar organic solvent is selected from the group consisting of methanol, ethanol, propanol, isopropanol, butanol, and isobutanol or combinations thereof, at a concentration of from 0 to about 90 parts of water in said solution.

11. A process comprising forming a coating in situ on an outer surface of a substrate, said coating comprising a metal oxide layer, said metal oxide layer formed by applying a solution comprising an organometallic compound and a polar organic solvent and/or water to said substrate; and curing said solution on said substrate in an oven at a temperature of from about 300° C. to about 600° C.

12. The process in accordance with claim 11, wherein said metal oxide is titanium oxide or zirconium oxide.

13. The process in accordance with claim 11, wherein the organometallic compound is a hydrolytically stable organic titanate, a hydrolytically stable zirconate, an alcoholytically stable titanate, or an alcoholytically stable zirconate.

14. The process in accordance with claim 13, wherein said hydrolytically stable organic titanate is titanium lactate, titanium acetylacetone chelate or combinations thereof.

15. The process in accordance with claim 13, wherein said hydrolytically stable zirconate is zirconium lactate, zirconium glycoate or combinations thereof.

16. The process in accordance with claim 13, wherein said alcoholytically stable organic titanate is titanium acetylacetone chelate, titanium acetylacetone/silane chelate, titanium ethylacetoacetate chelate, titanium triethanolamine chelate or combinations thereof.

17. The process in accordance with claim 13, wherein said alcoholytically stable organic zirconate is diethylcitrate chelated zirconate, triethanolamine zirconate or combinations thereof.

18. The process in accordance with claim 11, wherein said outer surface of said substrate comprises aluminum, aluminum alloy, titanium, titanium alloys, copper, copper iodide, brass, gold, zirconium, nickel, stainless steel, tungsten, chromium, or combinations thereof.

19. The process in accordance with claim 11, wherein said organometallic compound is in a concentration in said solution of from about 0.05% to about 50%, or from about 0.1% to about 20%.

20. The process in accordance with claim 11, wherein said polar organic solvent is selected from the group consisting of methanol, ethanol, propanol, isopropanol, butanol, and isobutanol or combinations thereof, at a concentration of from 0 to about 90 parts of water in said solution.

21. A xerographic system comprising a photoreceptor in accordance with claim 1.
